(19) United States
(12) Patent Application Publication
(10) Pub. No.: US 2003/0075557 A1
(43) Pub. Date: Apr. 24, 2003

(54) Pipette device with evaporation protection plate

(76) Inventors: Holger Deppe, Frankfurt (DE); Hanns Wurziger, Darmstadt (DE); Alexander Gross, Babenhausen (DE); Dirk Tomandl, Ober-Ramstadt (DE); Andreas Schober, Darmstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/258,748

(22) PCT Filed: Apr. 9, 2001
(86) PCT No.: PCT/EP01/04038

(30) Foreign Application Priority Data
Apr. 28, 2000 (DE) 100 20 771.5

(51) Int. Cl. B05B 7/00

(52) U.S. Cl. 222/54; 222/630

(57) ABSTRACT

When chemical substances are pipetted in individual microwells of a microwell array (4), problematic evaporation effects arise concerning the solvent with which the microwells are already filled. In order to prevent such undesired evaporation effects, a pipetting device for the automated pipetting of chemical substances having a holder (3), which receives at least one microwell array (4), and a pipetting head (11), which is fitted in such a way that it can be moved, is designed with the pipetting head (11) being fastened, by means of a holding device, to a plate (7) which follows the movements of the pipetting head (11) during the pipetting process. The plate (7) forms above the microwell array (4), in conjunction with a frame (5) tightly enclosing the microwell array (4), a sealed gas space (14) into which the pipetting head (11) protrudes through a matched hole (13) in the plate (7).

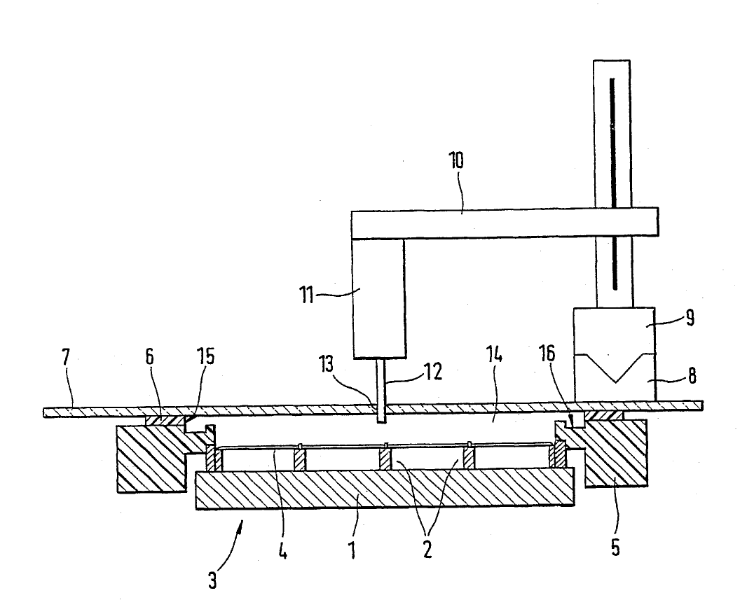

The invention relates to a pipetting device for the automated pipetting of chemical substances in microwell arrays having a holder, which receives at least one microwell array, and a pipetting head, which is fitted in such a way that it can be moved.

In the fields of combinatorial or analytical chemistry, the requirements concerning sample turnover and economy are becoming ever greater, and increasing attempts are therefore being made to process more and more individual samples simultaneously as well as to minimise the sample volumes used. Owing to progressive miniaturisation of the individual sample containers or reaction vessels, the use of so-called microwell arrays has now become standard practice. Microwell arrays consist of a large number of microwells which are, for example, arranged in a matrix layout and in the simplest case consist of a small cavity, but may also be complex reaction vessels made up of many individual components.

In order to fill the individual microwells rapidly and economically with small amounts of samples, automated pipetting devices are often employed. In such a device, a pipette is guided at a small distance above the individual microwells, and, the respective microwell is filled with an accurately measured amount of the appropriate chemical substance, usually dissolved in a solvent.

The problematic evaporation effects when pipetting a plurality of microwells in a microwell array become commensurately more significant when smaller amounts of the solvent are chosen for filling the individual microwell. Quantitative analysis is greatly compromised by uncontrolled evaporation, and comparative evaluation of successively pipetted microwells is virtually impossible. Therefore, the microwell array miniaturisation which has already been accomplished makes it necessary to take preventive measures against evaporation effects.

The use of a solvent with comparatively low volatility is not always a sufficient measure, especially since it is not possible to combine an arbitrary solvent with any chemical substance. Another possible way of reducing evaporation effects during the pipetting process is to put the entire pipetting device in a sealed container, in which a solvent-saturated atmosphere is already set up prior to the actual pipetting process. Since a saturated atmosphere cannot take any more solvent vapour, scarcely any evaporation of the solvent liquid out of the microwells occurs. Although it is easy and economical to maintain an atmosphere saturated with water vapour during pipetting, for solvents other than water this entails great expense or may be virtually impossible. Furthermore, in a container which is large enough to accommodate a pipetting device, it is always possible to encounter convection phenomena which promote rapid evaporation of the pipetted solutions.

The object of the invention is consequently to configure a pipetting device in such a way that undesired evaporation effects can be substantially reduced during a pipetting process with any solvents.

This object is achieved according to the invention in that the pipetting head is fastened, by means of a holding device, to a plate which is guided, by sliding or at a small distance, above the microwell array in such a way as to follow the movements of the pipetting head during the pipetting process and which forms above the microwell array, in conjunction with a frame tightly enclosing the microwell array, a sealed gas space into which the pipetting head protrudes through a matched hole in the plate. The effect of this is to significantly reduce the volume available for evaporation of the solvent. A solvent-saturated atmosphere quickly forms in the sealed gas space, so that scarcely any evaporation continues to take place. Furthermore, virtually no evaporation-promoting convection takes place in the very thin layer over the microwell array. With comparatively little design outlay, the undesired escape of any kind of solvent from the individual microwells during the pipetting process can be substantially reduced.

According to one configuration of the inventive concept, the pipetting head can be moved vertically out of the hole in the plate. The pipetting head can in this way be removed from the plate by a simple manual operation or under automatic control. The pipetting head can be refilled or changed during or after a pipetting process, without any solvent that escapes in an uncontrolled way directly: reaching the microwell array.

According to an advantageous embodiment of the inventive concept, the pipetting head is fastened to a vertically movable holding arm, which can be displaced lengthwise on a carriage along a guide rail on the plate. In order to permit automatic refilling of the pipetting head during or after a filling process, it is desirable if the pipetting head can be moved out of the filling position towards a storage container which contains a sufficiently large amount of the solutions to be pipetted. To that end, the arm holding the pipetting head is raised until the tip of the pipetting head is at a sufficient distance from the plate. The pipetting head, which is now freely movable, can then be displaced together with the holding arm along the guide rail to beyond the edge of the plate. The storage container is expediently located there, so that the pipetting head can take the solvent therefrom in an automated process. Owing to the timesaving which it permits, automatic refilling leads to a further reduction of evaporation during a pipetting process.

Preferably, the plate is large enough for the frame, which tightly surrounds the, microwell array, to be fully covered even when the hole in the plate is positioned on the other side of the frame next to the microwell array. When the pipetting head is lifted off the plate in order to be filled, the hole which is left means that the gas space above the microwell array is no longer fully sealed. In order to keep the gas space sealed in this case as well, and hence to prevent evaporation effects which would otherwise be promoted, the plate is moved to the side until the hole in the plate is on the other side of the frame tightly enclosing the microwell array. The pipetting head can then be lifted vertically out of the hole in the plate without establishing communication between the gas space, which is still sealed, and the surrounding atmosphere.

According to an advantageous configuration of the inventive concept, a trough-like channel, which receives a volume of liquid, is arranged along the frame inside the sealed gas space. Prior to the pipetting process, this trough-like channel can be filled with a sufficient amount of the same solvent as the one used for the pipetting. Unlike the solvent used during the pipetting process, the volume of solvent with which the trough-like channel is filled is intended for maximised evaporation. In this way, a solvent-saturated atmosphere can be set up inside the sealed gas space in advance of a pipetting process, so that evaporation of the solvent which has already been pipetted can be further reduced during the pipetting process.

According to an advantageous embodiment of the inventive concept, the plate is moved by sliding on a slide support which has a wiping edge and is fitted above the trough-like channel. Such a slide support may, for example, be made from PTFE so that problematic friction effects can be substantially avoided. In spite of all the precautionary measures taken against evaporation, small amounts of evaporated solvent may gather in the form of a condensate on the bottom of the plate. When the plate is moved, a corresponding surface of the bottom of the plate squeezes over the slide support. The solvent which has condensed there is then taken off by the wiping edge and can drip or flow into the trough-like channel fitted underneath.

According to an advantageous configuration of the inventive concept, the temperature of the microwell array can be regulated. It is hence possible to guarantee identical filling conditions during a pipetting process, and even over the course of several filling processes. Furthermore, the evaporation behaviour of the solvent which has already been pipetted into microwells can be controlled via the temperature of the microwell array.

Preferably, the temperature of the mobile plate above the microwell array can be regulated. On the one hand, because of the large contact surface area between the plate and the sealed gas space, the plate temperature has a direct effect on the enclosed gas volume. On the other hand, condensation of the solvent on the bottom of the plate can be substantially avoided through suitable choice of the mobile plate temperature. The problematic droplet formation on the bottom of the mobile plate can hence be avoided, so that solvent drops falling uncontrollably onto the microwell array do not undesirably change the accurately measured solvent volume in the microwells.

Another advantageous configuration of the inventive concept is the subject of a further dependent claim.

An illustrative embodiment of the invention will be explained in more detail below, and is represented in the drawing.

The single FIGURE shows a section through a pipetting device for the automated pipetting of chemical substances in microwell arrays.

A holder 3, which consists of a base plate 1 and fastening devices 2, is used to accommodate a microwell array 4. Around the holder 3, there is a frame 5 which tightly surrounds the holder 3 and the microwell array 4. A slide support 6, for example manufactured from PTFE, is fitted at the top of the frame 5. A guide rail 8 is permanently fastened to a plate 7 which bears on the slide support 6 in such a way that the said plate 7 can be moved. A carriage 9, on which a height-adjustable holding arm 10 is mounted, is located on this guide rail 8 in such a way that the said carriage 9 can be displaced lengthwise. A pipetting head 11 is fitted on the holding arm 10 and its pipette nozzle 12 protrudes through a hole 13 in the plate 7 into a gas space 14 which is fully sealed by the microwell array 4, the frame 5 and the plate 7. At the start of the pipetting process, the pipetting head 11 is respectively positioned over that microwell of the microwell array 4 which is to be filled, by displacing the plate 7 together with the structures fastened to it, in particular the pipetting head 11 with the pipetting nozzle 12 which protrudes through the opening 13 in the plate 7.

The slide support 6 has a wiping edge 15 on the side facing the sealed gas space 14. When the plate 7 is displaced outwards over the slide support 6, the solvent which has condensed on the bottom of the plate 7 is taken off by the wiping edge 15 of the slide support 6 and runs down the inside of the frame 5 located underneath.

A trough-like channel 16 is formed slightly below the slide support 6 on the inside of the frame 5. The condensed solvent which has been wiped off the plate 7 collects there. Furthermore, a sufficient amount of the solvent may already have been deposited in the trough-like channel 16 prior to a pipetting process. A solvent-saturated atmosphere is then quickly set up in the sealed, gas space 14 by the solvent evaporating out of this trough-like channel 16. This substantially suppresses the effects due to solvent, which has already been pipetted, evaporating out of the microwells in the microwell array 4.

For simple controllability during the pipetting process it is expedient if the mobile plate 7 above the microwell array 4 is optically transparent. In order to guarantee a maximal application range for the pipetting device, all the constituent parts of the device which directly surround the sealed gas space 14 may consist of materials which are substantially inactive in chemical terms.

For certain applications, it may be advantageous if the plate 7 is not displaced over a spatially fixed frame 5, but instead the holder 3 and frame 5 are moved relative to a permanently fastened plate 7 in order to position the microwell array 4 relative to the pipetting head 11 prior to each pipetting process.

Patent claims:

1. Pipetting device for the automated pipetting of chemical substances in microwell arrays having a holder, which receives at least one microwell array, and a pipetting head, which is fitted in such a way that it can be moved, characterised in that the pipetting head (11) is fastened, by means of a holding device, to a plate (7) which is guided, by sliding or at a small distance, above the microwell array (4) in such a way as to follow the movements of the pipetting head (11) during the pipetting process and which forms above the microwell array (4), in conjunction with a frame (5) tightly enclosing the microwell array (4), a sealed gas space (14) into which the pipetting head (11) protrudes through a matched hole (13) in the plate (7).

2. Pipetting device according to claim 1, characterised in that the pipetting head (11) can be moved vertically out of the hole (13) in the plate (7).

3. Pipetting device according to claim 1, characterised in that the pipetting head (11) is fastened to a vertically movable holding arm (10), which can be displaced lengthwise on a carriage (9) along a guide rail (8) on the plate (7).

4. Pipetting device according to claim 1, characterised in that the plate (7) is large enough for the frame (5), which tightly surrounds the microwell array (4), to be fully covered even when the hole (13) in the plate (7) is positioned on the other side of the frame (5) next to the microwell array (4).

4. [sic] Pipetting device according to claim 1, characterised in that a trough-like channel (16), which receives a volume of liquid, is arranged along the frame (5) inside the sealed gas space (14).

5. Pipetting device according to claim 4, characterised in that the plate (7) is moved by sliding on a slide support (6) which has a wiping edge (15) and is fitted above the trough-like channel (16).

6. Pipetting device according to claim 1, characterised in that the temperature of the microwell array (4) can be regulated.

7. Pipetting device according to claim 1 or 6, characterised in that the temperature of the mobile plate (7) above the microwell array (4) can be regulated.

8. Pipetting device according to claim 1, characterised in that the mobile plate (7) above the microwell array (4) is optically transparent.
